(19) United States
(12) Patent Application Publication
(10) Pub. No.: US 2026/0303933 A1
(43) Pub. Date: Oct. 1, 2026

(54) THERMAL CAMERA LENS DESIGNWITH IMPROVED CENTER-FIELD DETECTION RANGE

(71) Applicant: Microsoft Technology Licensing, LLC, Redmond, WA (US)

(72) Inventors: Kevin James MATHERSON, Windsor, CO (US); Zachary David DEROCHER, Yokohama-shi (JP)

(73) Assignee: Microsoft Technology Licensing, LLC, Redmond, WA (US)

(21) Appl. No.: 19/089,855

(22) Filed: Mar. 25, 2025

(51) Int. Cl. H04N 23/23; G02B 27/01; H04N 23/21; H04N 23/55; H04N 23/57

(52) U.S. Cl. CPC H04N 23/23; H04N 23/21; H04N 23/55; H04N 23/57; G02B 2027/0138; G02B 2027/0141; G02B 27/0172; G02B 2027/0178

(57) ABSTRACT

A thermal imaging camera system having a compact form factor for use in applications such as head-mounted display devices employs a lens design having a specific barrel distortion profile that increases the angular resolution of the lens while maintaining an overall field of view (FOV). The barrel distortion profile provides a corresponding increase in pixel angular resolution (i.e., pixels per angle of FOV) in a central region of the FOV of the camera as compared to that provided by a conventional rectilinear lens having an idealized zero distortion profile. The increase in angular resolution enables improvement in long-range center-field detection of thermal signatures of objects and/or people, while the optical distortion allows the lens to satisfy the full angular FOV requirements of the thermal imaging camera system. In illustrative embodiments, the lens designs utilize optical distortion profiles that deviate from the idealized lens using higher-order terms in a mathematical model.

### BACKGROUND

Thermal imaging camera systems are increasingly being integrated into head-mounted display (HMD) devices to enhance situational awareness and provide critical information in various use environments, such as consumer, healthcare, and emergency services. In mixed-reality applications, by combining thermal imaging into overlays of virtual images, HMD devices with thermal imaging camera systems can provide real-time, contextual information to users, improving decision-making and operational efficiency in many situations.

### SUMMARY

A lens in a thermal imaging camera system is designed with a specific barrel distortion profile mathematically described using a polynomial series with higher-order (e.g., cubic and/or quartic) terms to increase the angular resolution of the lens in a center region of the field of view (FOV) of the camera system. The increased angular resolution of the lens provides a corresponding increase in the pixel angular resolution for an infrared (IR) radiation-sensitive sensor in the thermal imaging camera system to improve the center-field detection range of thermal signatures of objects or people.

Advantageously, the barrel distortion lens design improves the center-field detection range while maintaining the same overall FOV of the thermal imaging camera system as with a conventional rectilinear lens having an idealized profile with zero distortion. In mixed-reality HMD devices, for example, a relatively wide thermal imaging FOV provides benefits by enhancing thermal signature detection capabilities and by being more closely matched to a human visual system's natural FOV which increases spatial awareness and reduces tunnel vision and disorientation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### DESCRIPTION OF THE DRAWINGS

FIG. 1 shows an illustrative thermal imaging camera that is configurable for use in various electronic devices;

FIG. 2 shows pictorial views of an illustrative example of a head-mounted display (HMD) device having a sensor package that includes a thermal imaging camera;

FIG. 3 shows illustrative mixed- and virtual-reality embodiments of an HMD device;

FIG. 4 shows illustrative components of an HMD device including a display system and sensor package;

FIG. 5 shows illustrative components of a sensor package in an HMD device;

FIG. 6 illustratively shows virtual images that are overlayed onto real-world images within a field of view (FOV) of a mixed-reality HMD device;

FIG. 7 shows an illustrative lighted use environment for an HMD device having a thermal imaging camera system;

FIG. 8 shows an illustrative darkened use environment for an HMD device having a thermal imaging camera system;

FIGS. 9A-D provide views of an illustrative thermal imaging sensor;

FIGS. 10A and 10B provide views of an illustrative thermal imaging camera system with various different optical lenses;

FIG. 11 shows an illustrative FOV of a thermal imaging camera system described by angles in horizontal, vertical, or diagonal orientations;

FIG. 12 shows illustrative internal components of a thermal imaging camera system;

FIGS. 13A and 13B show a comparison between a conventional rectilinear lens design and a lens designed with a specific barrel distortion profile to improve pixel angular resolution in the center region of an image;

FIG. 14 shows an illustrative test target as seen through a rectilinear lens design having an idealized zero distortion profile;

FIG. 15 shows an illustrative test target as seen through a lens design having an f-theta distortion profile;

FIG. 16 shows an illustrative test target as seen through a lens design having a quartic distortion profile;

FIG. 17 is a graph showing angular resolution for a display system in pixels per degree versus field angle for different levels of distortion in thermal imaging camera lenses;

FIG. 18 is a flowchart of an illustrative method;

FIG. 19 is a block diagram of an illustrative mixed-reality HMD device that is configurable to use the present thermal imaging camera lens design;

FIG. 20 shows an illustrative foveated display for virtual images rendered on a display system of an HMD device;

FIG. 21 is a functional block diagram of an illustrative computing device that may be used, at least in part, to implement aspects of the present principles.

Like reference numerals indicate like elements in the drawings. Elements are not drawn to scale.

### DETAILED DESCRIPTION

A thermal imaging camera system includes a thermal imaging sensor, a lens, and an image processor. The system is adapted for use in applications where a compact form factor is generally desired, such as head-mounted display (HMD) and other wearable devices, handheld devices such as thermal scanners, smartphones, personal computers, and other computing devices. While typical commercially available compact thermal imaging sensors are relatively limited in terms of pixel size and resolution, they are successfully utilized in a range of applications and use environments.

Thermal imaging cameras can capture infrared (IR) radiation emitted by objects with a temperature above absolute zero (−273° C./−459° F.) located within a field of view (FOV) of the camera. The cameras use a sensor comprising an array of infrared-detector elements called microbolometers arranged in the focal plane of the camera. The microbolometer array comprises a grid of individual microbolometers that each function to provide a pixel in a thermal image. The array is two-dimensional and typically rectangular in shape, although non-rectangular shapes are usable in some implementations. The microbolometers detect the IR radiation and convert it into electrical signals by sensing a difference in thermal radiation relative to a reference. Heat generated by the incoming IR radiation is compared to the microbolometer's own initial temperature. Compact thermal imaging cameras commonly use uncooled microbolometers in which the lack of cooling can reduce sensor sensitivity.

The image processor uses the electrical signals of the infrared images to generate corresponding visible images or other information that are rendered by a display engine or other suitable system for a user of an electronic device. In some applications, the electrical signals are used as data sources to create or enhance various types of user experiences. For example, in a mixed-reality HMD device or heads-up display (HUD), thermal imaging data may be utilized in virtual images that are rendered over or with views of the real world in the user's FOV to enhance visualization and interaction with the real-world environment.

Optical lenses of varying types, sizes, and functionality are utilized to focus IR radiation emitted from a target object onto the sensor as suited to implement a thermal imaging camera that meets particular design goals. Generally, as the focal length of a lens increases, the FOV of the camera decreases. The FOV describes the viewable area of the lens that can be focused on the thermal imaging sensor. Conventional lenses with relatively longer focal lengths enable the sensor to detect thermal signatures of targets (e.g., objects and people) at greater distances because the pixel angular resolution is effectively increased to provide higher image quality and detail.

Increased detection range for thermal imaging is advantageous in many applications. For example, longer detection range enhances identification of persons or objects of interest. Firefighters using HMD devices, for example, can assess and identify fire activity and hot spots from a safe distance. First responders can locate victims through smoke, fog, and foliage in varying weather conditions. In industrial applications, long-range thermal imaging can help to detect equipment failure and hazards from a safe distance. In fixed thermal imaging camera system surveillance and security applications, increased detection range may allow fewer systems to be deployed to surveil a given area.

In conventional thermal imaging camera systems, as range detection is increased, for example by increasing the focal length of the lens, the overall FOV for the system is diminished which may be suboptimal for some applications. For example, a narrower FOV may hinder situational awareness, reduce the quality of the immersive experience in mixed- and virtual-reality scenarios, or negatively impact the quality and/or amount of thermal imaging data that may be captured for application use.

The present thermal imaging camera lens design deviates from a rectilinear lens (i.e., an idealized lens having minimal to zero distortion) by employing a specific barrel distortion profile. The distortion profile when mathematically characterized, for example, using a polynomial expression, is defined by higher-order terms (i.e., terms beyond a simple quadratic approximation of the lens). The distortion profile provides for improved pixel angular resolution in the center of the camera's FOV by increasing the angular resolution of the center region of the lens.

The increase in angular resolution improves the center-field detection range of thermal signatures by the sensor by virtue of improved thermal data fidelity in the center of the captured images. Advantageously, the increased detection range is achieved while the FOV of the thermal imaging camera system is maintained at the same size as with a conventional rectilinear lens having an idealized zero level of distortion. The distortion in the thermal image from the lens can typically be corrected, as needed, for thermal imaging data usage by applications through suitable calibration and/or correction algorithms implemented by the image processor in the system.

In an illustrative embodiment, the thermal imaging camera lens design has an f-theta distortion profile. Higher order polynomial terms may be utilized when mathematically describing the lens with the f-theta distortion profile to ensure that the angular resolution of the lens design of the center field is higher relative to a rectilinear lens. In another illustrative embodiment, the thermal imaging camera lens design has a quartic distortion profile. In this lens design, a fourth-order term in a mathematical polynomial lens model provides a further increase angular resolution in the center of the FOV relative to the edges compared with each of the rectilinear and f-theta lens designs. In each illustrative embodiment, the lens designs with distortion maintain the same overall FOV as with the rectilinear lens design.

While center-field pixel angular resolution for the camera is further increased with the quartic lens with corresponding improvement in pixel angular resolution and thermal image detection range, resolution at the edges of the FOV is reduced. However, the tradeoff between the center field (or on-axis field) and off-axis/edge thermal image resolution is warranted for applications in which a relatively wide FOV is required but the reduced resolution at the edges is acceptable.

For example, some electronic devices have eye tracking and foveated display capabilities in which rendering and resolution are variably implemented and optimized based on the area of the display where the user is looking. Humans naturally direct their gaze towards the center of their visual field to capture the most detail and information. This is because the fovea, located at the center of the retina, is densely packed with photoreceptor cells that provide sharp vision. Thus, reduced pixel angular resolution for thermal images at the FOV edges may be acceptable in implementations in which foveated display systems are utilized.

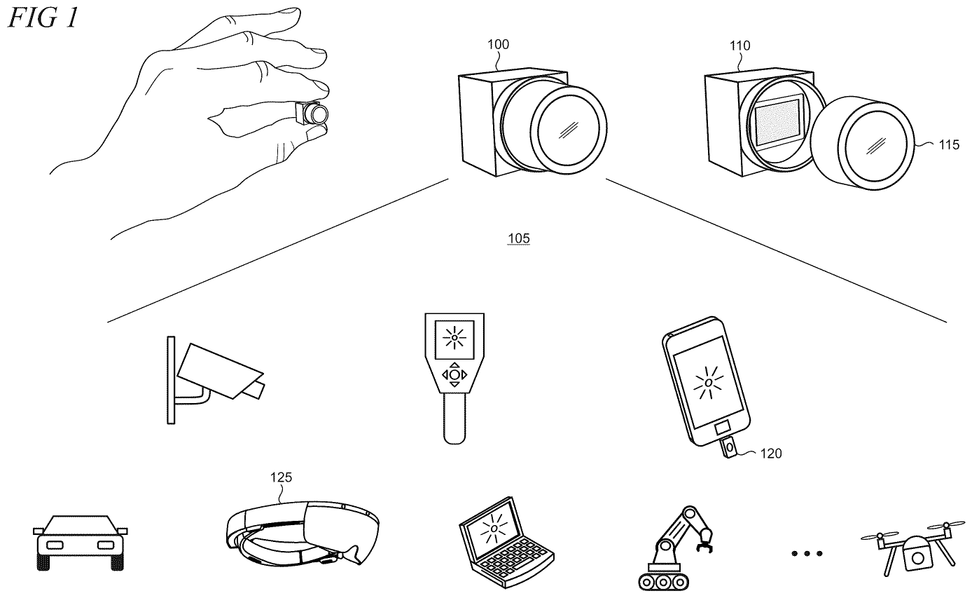

Turning now to the drawings, FIG. 1 shows an illustrative thermal imaging camera 100 that is configurable in different instances for use in various electronic devices (collectively indicated by reference numeral 105). It is noted that the devices are not drawn to scale. The thermal imaging camera comprises a thermal imaging sensor 110 and a lens 115. In many typical electronic device embodiments, the thermal imaging camera has a compact form factor, but the camera can be sized and implemented using various form factors as suitable for a given application.

The electronic devices 105 include by way of example, without limitation, surveillance cameras, handheld thermal scanning devices, smartphones (in which the thermal imaging camera systems may be implemented using an internal component or an external plug accessory camera 120), automobiles, HMD devices 125 and other body-worn devices, personal computers and multimedia consoles, robots and automation equipment, aerial vehicles such as drones, and the like.

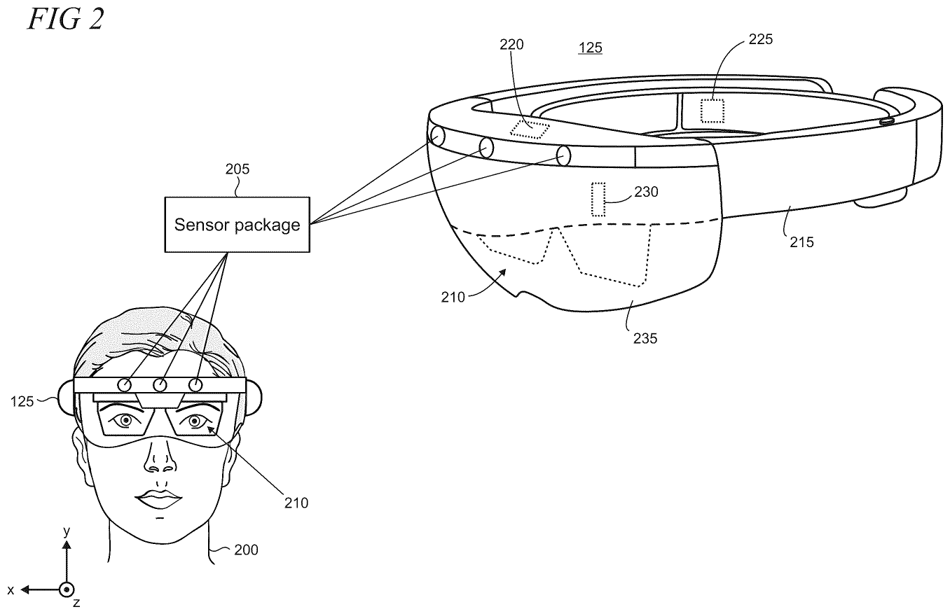

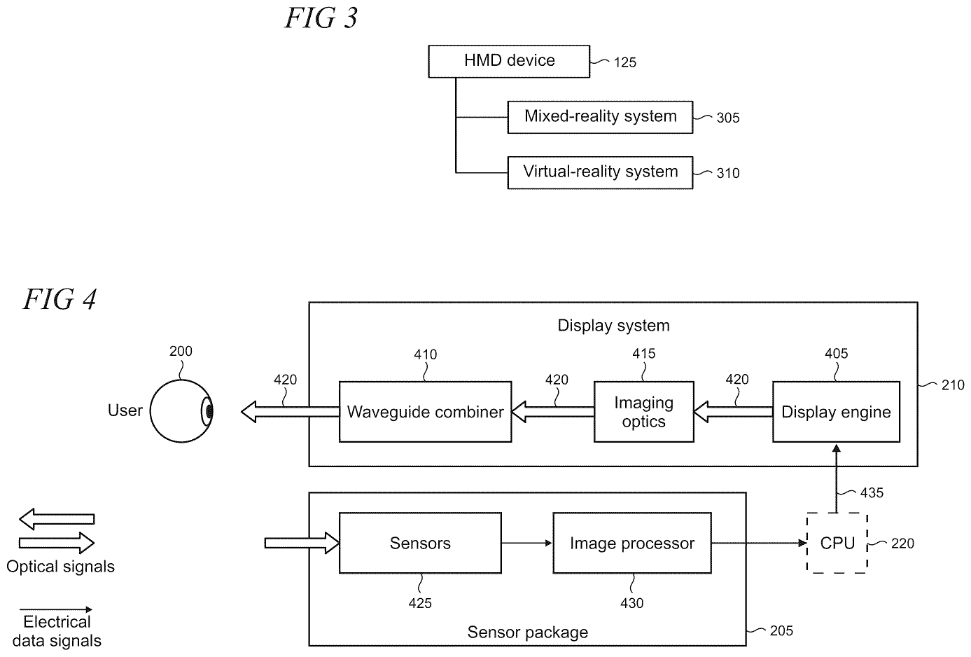

FIG. 2 shows pictorial views of an illustrative example of an HMD device 125 as worn by a user 200. The HMD device includes a sensor package 205 that includes a thermal imaging camera. The HMD device is alternatively configurable with a mixed-reality system 305 or virtual-reality system 310, as shown in FIG. 3.

Returning to FIG. 2, the HMD device includes a display system 210 and a frame 215 that wraps around the head of the user to position the display system near the user's eyes. For a mixed-reality experience, the display system is see-through so that the user of the HMD device can view physical, real-world objects in the physical environment over which pixels for virtual objects are overlayed.

The frame 215 further supports additional components of the HMD device 125, including a central processing unit (CPU) 220, an inertial measurement unit (IMU) 225, and an eye tracking system 230. The CPU includes logic and associated computer memory configured to receive sensory signals from the IMU and sensor package to provide display signals to the display system 210, to derive information from collected data, and to enact various control processes described herein. The HMD device includes a transparent eye shield 235 that protects the display system from damage, for example, due to handling and environmental conditions.

FIG. 4 shows details of the display system 210 and sensor package 205 in the HMD device 125 when configured for mixed-reality user experiences. The display system includes a display engine 405 and at least a partially-transparent waveguide-based optical combiner (referred to herein as a see-through waveguide combiner 410) that is located in front of the user's eyes when the HMD device is donned. The display system may further include imaging optics 415 such as magnifying and/or collimating optical components, reflective components, micro-electro-mechanical system (MEMS) scanning systems, and the like to provide virtual images and real-world images over a light path 420.

The display engine 405 is a source of virtual-world objects or holographic images (collectively referred to herein as “virtual images”) using projector-based emissive panels or other suitable displays or micro-displays operating in transmission, reflection, or emission. The display engine delivers light 420 for virtual images to the waveguide combiner 410 to provide a display to the user 200.

The sensor package 205 includes one or more sensors 425 and an image processor 430. The image processor may be embodied as a single component that interoperates with multiple different sensors. Alternatively, each sensor interoperates with its own unique image processor. In some implementations, the image processor is embodied using the CPU 220 and/or interoperates with the CPU. The display engine 405 is arranged to generate virtual images responsive to electrical data signals 435 from the image processor and/or CPU. For example, when the sensor is a thermal imaging camera, thermal images are transmitted to the display engine for rendering on the waveguide combiner in the display system.

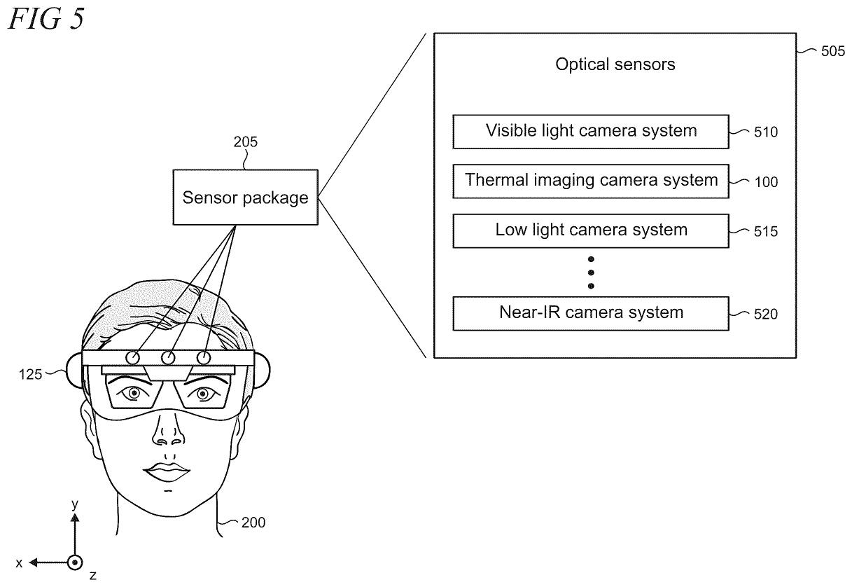

As illustratively shown in FIG. 5, the sensor package includes optical sensors 505 that are operated to generate electrical data signals from electromagnetic radiation sources that are sensed in the HMD device operating environment. The sensors include a visible light camera system 510 configurable for monoscopic or stereoscopic operations in polychromatic (e.g., red, green, blue (RGB)) or monochromatic arrangements. The optical sensors further include the thermal imaging camera system 100, a low light camera system 515, and near-IR camera system 520. Other sensors (not shown) such as depth sensors, time of flight sensors, etc., may also be utilized in the sensor package in the HMD device 125 in some cases. As noted above, these optical sensor systems include a sensor, suitable optical lenses in most cases, and a shared or unique image processor.

The thermal imaging camera system 100 is arranged to detect electromagnetic radiation in the IR range, typically in the longwave infrared (LWIR, 8 um-12 um) where the IR radiation has relatively long wavelengths, although midwave-IR (3 um-5 um), or shortwave IR (1 um-3 um) radiation may also be detected in some implementations. In an illustrative example, the thermal imaging camera includes an uncooled thermal imaging sensor using a microbolometer array that measures the magnitude or power of an incident electromagnetic wave/radiation. To measure the radiation, the array uses a thin layer of absorptive material (e.g., metal) connected to a thermal reservoir through a thermal link. The incident IR wave strikes and heats the material. In response to the material being heated, the microbolometer can detect a temperature-dependent electrical resistance. That is, changes to environmental temperature causes changes to the microbolometer's temperature, and these changes can be converted into an electrical signal to produce a thermal image of the target object in the FOV of the thermal imaging camera.

The electrical signal produced by the microbolometer array is processable by the image processor 430. For example, in various illustrative embodiments, the image processor can process the signal to implement one or more of camera calibration, thermal image correction, gain control, dynamic range compression, thermal image detail enhancement, thermal image edge enhancement, noise reduction, color mapping (e.g., visible colors are mapped to different sensed temperatures for the target), data filtering, data conversion, or image fusion in which multiple different images of the same or different types are joined (e.g., a thermal image is joined with an image of a real or virtual object).

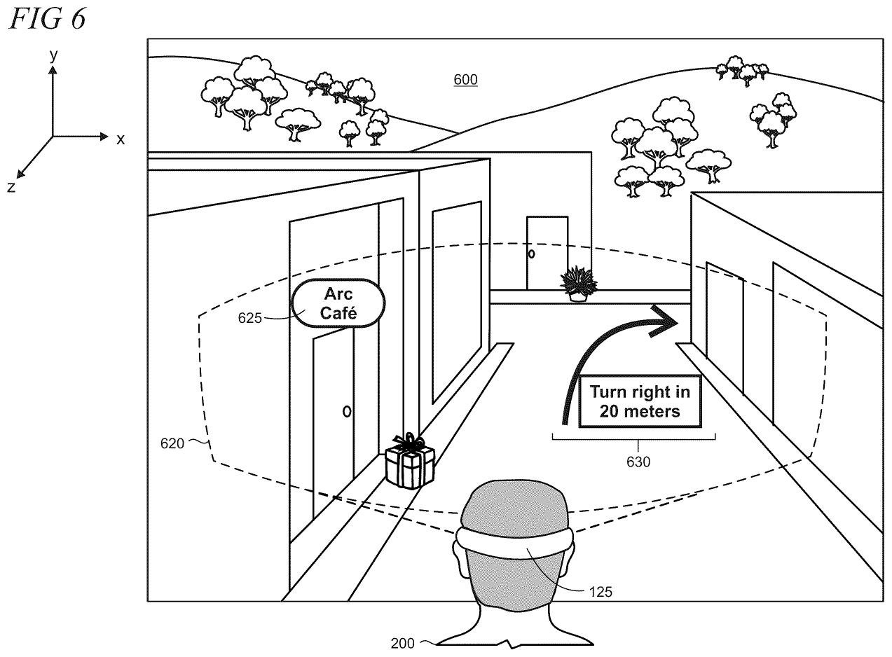

The display system 210 and sensor package 205 (FIG. 2) are utilized, in an illustrative example, to support a mixed-reality user experience for the user 200 of the HMD device 125, as illustratively shown in FIG. 6. The display engine generates virtual images that are guided by the waveguide combiner to the user. Having a see-through portion, the waveguide combiner in the display system enables the user to perceive light from the real world. The display system renders images of various virtual objects that are superimposed over the real-world images that are collectively viewed using the see-through waveguide display to thereby create a mixed-reality environment 600 within the HMD device's FOV 620.

In the illustrative example shown in FIG. 6, the user 200 is physically walking in a real-world urban area that includes city streets with various buildings, stores, etc., with countryside in the distance. The FOV of the cityscape viewed on HMD device 125 changes as the user moves through the real-world environment and the device can render static and/or dynamic virtual images over the real-world view. In this illustrative example, the virtual images include a tag 625 that identifies a restaurant business and directions 630 to a place of interest in the city. The mixed-reality environment 600 seen visually on the near-eye display system is also supplemented by audio and/or tactile/haptic sensations produced by the HMD device in some cases.

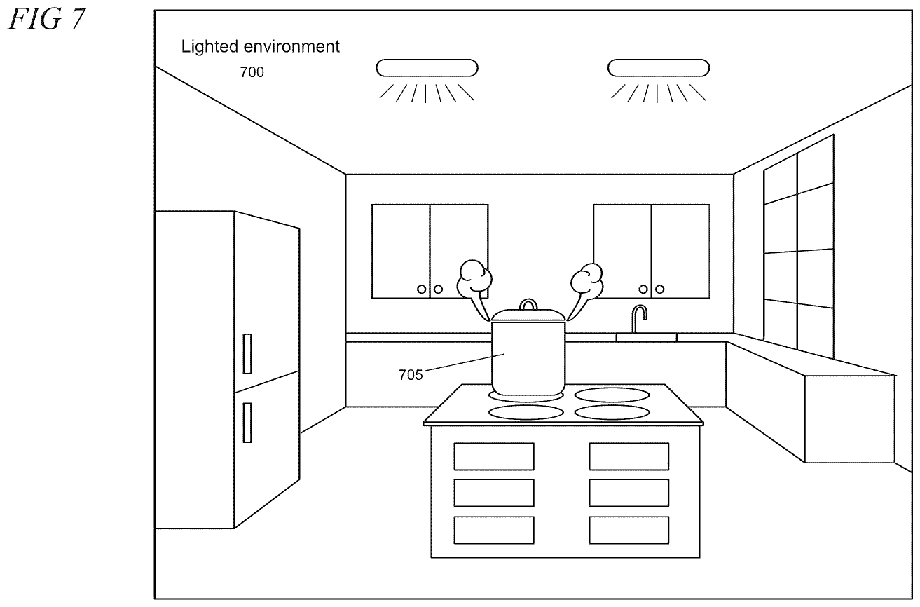

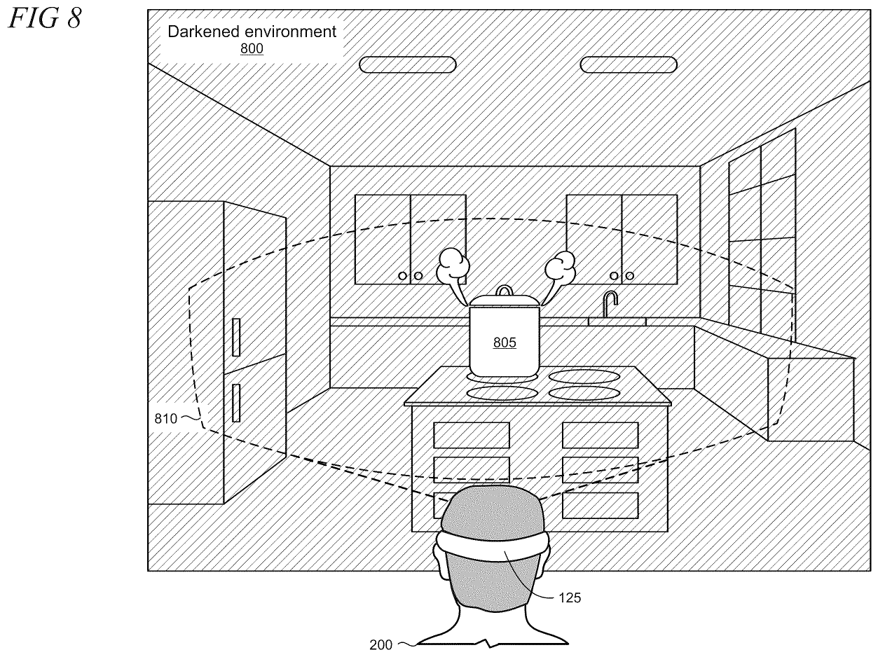

FIGS. 7 and 8 show another illustrative example of a mixed-reality user experience provided to the user 200 of the HMD device 125 with the thermal imaging camera system 100. FIG. 7 shows an illustrative lighted indoor HMD device use environment 700 in which a pot 705 of water is boiling on a stove. FIG. 8 shows a darkened environment 800 that would normally present a hazard to the user 200 because the light level is too low for the user to ordinarily see the pot through the waveguide combiner. However, the HMD device 125 is able to detect the hot pot using the thermal imaging camera system and render a visible virtual image 805 of the pot within the FOV 810 of the HMD device's display system.

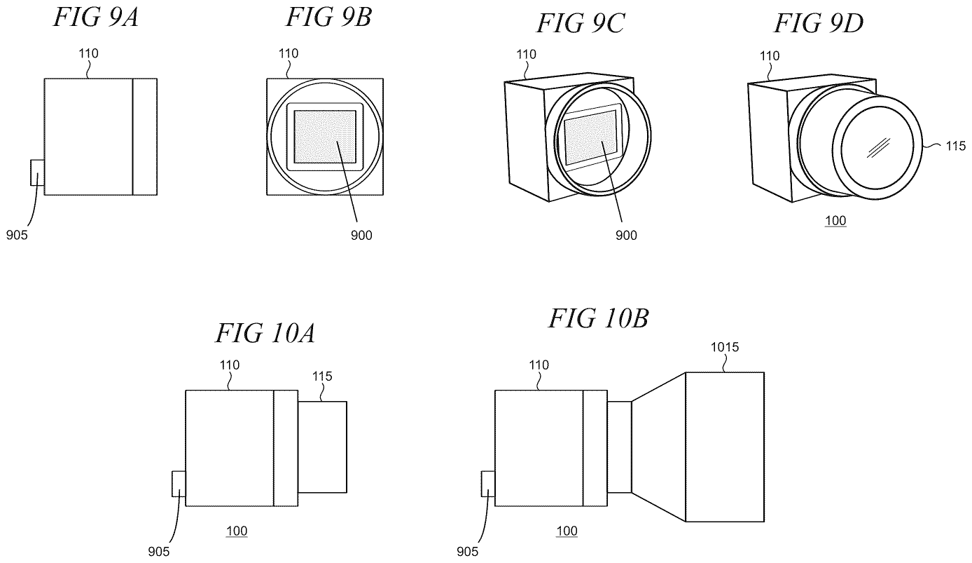

The thermal imaging camera system 100 may be arranged in different embodiments to suit various different applications. FIGS. 9A-D provide views of an illustrative thermal imaging sensor 110 and camera 100 (i.e., sensor plus lens 115). In this illustrative example, the camera system is configured with a small form factor using an uncooled microbolometer array 900 to suit HMD device applications.

The thermal imaging camera system 100 includes a connector 905 for operatively coupling the system to the display engine 405 (FIG. 4) or other suitable components. The connector can support standard wired or wireless connectivity and communication protocols such as USB (universal serial bus) or Wi-Fi. Alternatively, proprietary connectivity and communication protocols may be supported.

FIGS. 10A and 10B provide views of the thermal imaging camera system 100 with different optical lenses 115 and 1015 providing different respective focal lengths and FOVs. In some cases, the spectral response of the lenses may be tailored to meet specific application requirements. In addition, the lenses may include coatings to provide protection against expected environmental conditions and/or tune the transmission and sensitivity characteristics of the lenses.

As discussed above, with a fixed sensor size, the focal length of the lens affects the FOV of the camera and the detection range for thermal signatures of target objects and people. FIG. 11 shows an illustrative FOV 1100 of the thermal imaging camera system 100. The FOV may be described by angles in horizontal, vertical, or diagonal orientations.

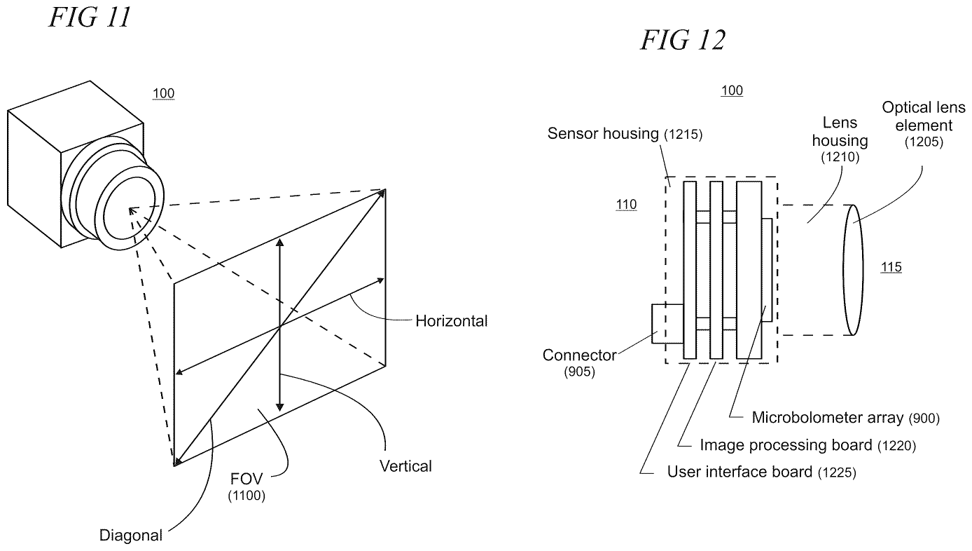

FIG. 12 shows illustrative internal components of the thermal imaging camera system 100. The lens 115 includes an optical lens element 1205 that is disposed in a lens housing 1210. The lens element is typically fabricated from a material that is transparent to IR wavelengths such as germanium, zinc selenide, or chalcogenide glass. The lens element is configured to focus thermal radiation from the target to the microbolometer array 900 disposed in a sensor housing 1215. In this illustrative embodiment, an image processing board 1220 supports the internally-disposed image processor 430 (FIG. 4). In alternative embodiments, the internal component is replaced or supplemented by external processors.

A user interface board 1225 supports various hardware and/or software components needed to support connectivity of the thermal imaging camera system 100, via the connector 905, to other systems and components in the HMD device 125 (FIG. 1). For example, the user interface board provides connectivity to enable one or more of data transfer, power management, or configuration and control of the thermal imaging camera system. The user interface board may also support interfaces to various software applications operating on the HMD device to enable software-controlled and/or operated features, capabilities, and user experiences using the thermal imaging camera system. The user interface board can support connectivity and software interfaces through the physical connector 905 using standardized or proprietary protocols or be interfaced using suitable wireless communication protocols.

In accordance with the present principles, the lens 115 (FIG. 1) of the thermal imaging camera system 100 is configured with a specific distortion profile that functions to increase the pixel angular resolution at the center part of the FOV of the camera compared to a rectilinear lens with the idealized zero distortion profile.

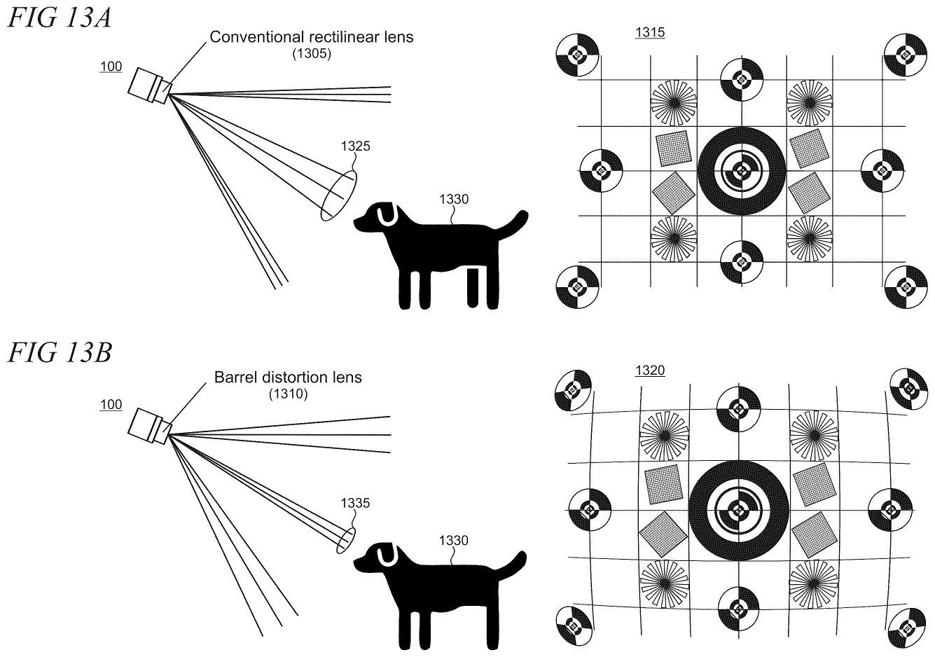

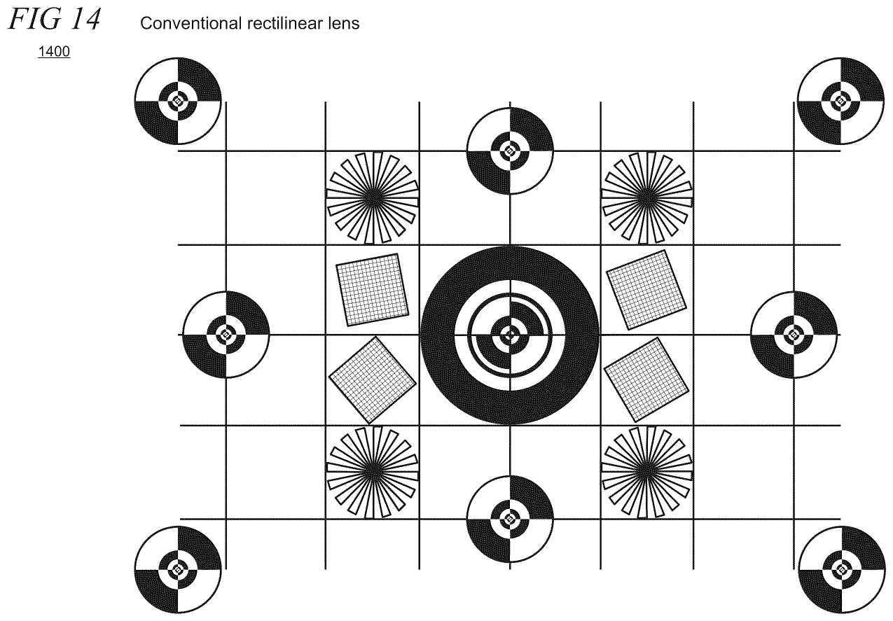

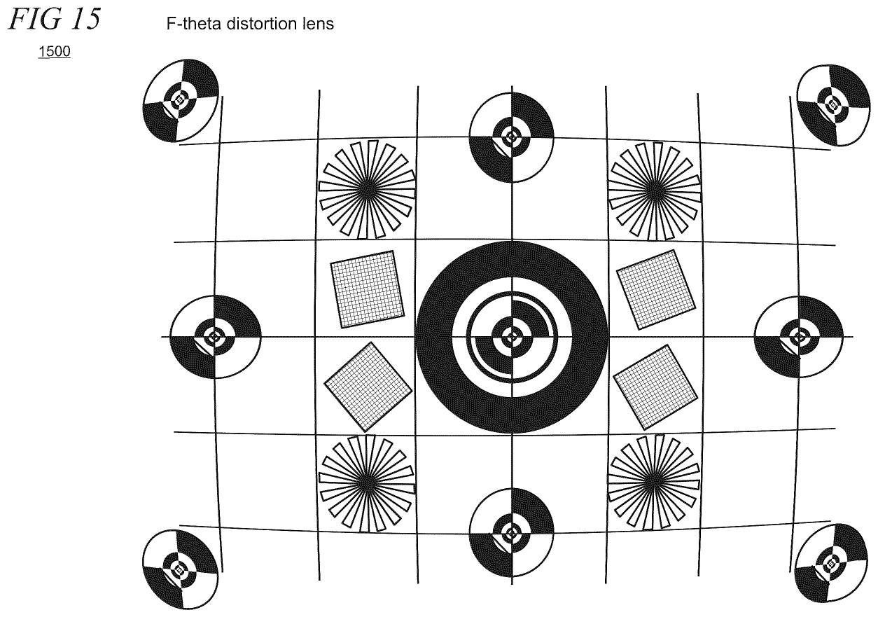

FIGS. 13A and 13B show a comparison between a conventional rectilinear lens design 1305 having an idealized zero distortion profile and a lens 1310 designed with a specific distortion profile to increase pixel angular resolution in the center area of an image. A test pattern having straight lines and perfectly circular geometric shapes, when viewed through the rectilinear lens, appears as an image 1315 without distortion such that the lines remain straight and the circles remain perfectly circular across the entirety of the FOV. Thus, the rectilinear lens keeps straight lines in the real world straight on the thermal imaging sensor and the corresponding thermal image.

By comparison, the same test pattern, when viewed through the lens 1310 with a barrel distortion profile, presents a fisheye image 1320 where straight lines appear curved and the image bulges out in the center of the FOV. Thus, the barrel distortion lens 1310 warps straight lines and enlarges the center field of the FOV. The distortion imparted by the lens provides for more pixels of the thermal image sensor to be distributed over the center of the FOV to thereby increase the pixel angular resolution for that part of the FOV. The increase in angular resolution is pictorially shown in FIGS. 13A and 13B where rays 1325 for center-field pixels cover a relatively larger area of the target 1330 for the rectilinear lens as compared to the rays 1335 for center-field pixels for the barrel distortion lens which cover a smaller area of the target.

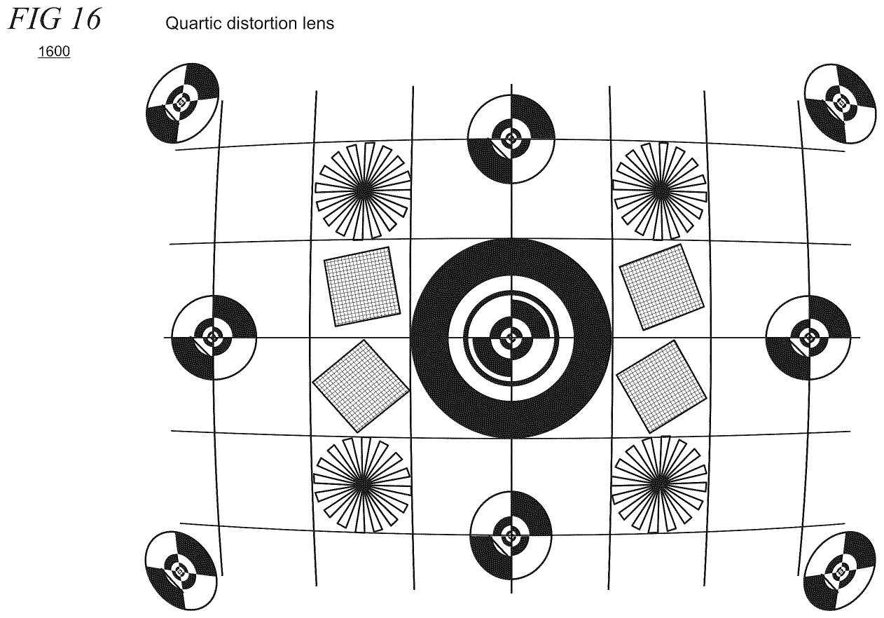

FIG. 14 is an enlarged view of the image 1400 of the test pattern as viewed through the rectilinear lens design having an idealized zero distortion profile. FIG. 15 shows an enlarged view 1500 of the test pattern as viewed through a first illustrative embodiment of a thermal imaging camera lens design having an f-theta distortion profile. The f-theta lens design has a distortion profile that maintains a constant pixel angular resolution across the entire thermal image. The pixel angular resolution in that region, is increased by approximately 8.5% as compared to the test image seen through the rectilinear lens design shown in FIG. 14 while maintaining the same horizontal FOV of 55 degrees and overall image size.

FIG. 16 shows an enlarged view 1600 of the test pattern as viewed through a second illustrative embodiment of thermal imaging camera lens design having a quartic distortion profile. With a quartic lens, there is greater magnification (i.e., bulging) at the center of the image with more distortion (i.e., line warping/curvature) at the edges of the FOV. The pixel angular resolution is increased by approximately 25% as compared to the rectilinear lens design. The quartic distortion profile maintains the same horizontal FOV of 55 degrees and a constant image size.

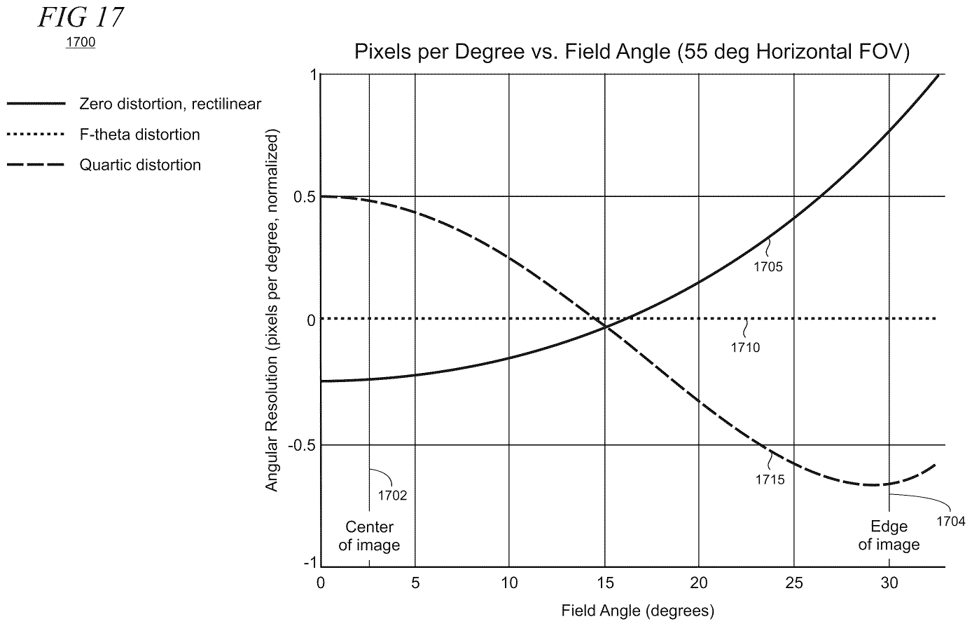

FIG. 17 is a graph 1700 showing angular resolution for the display system 210 (FIG. 2) in pixels per degree versus field angle for rectilinear, f-theta, and quartic lens designs. Resolution values for the center field of a displayed image (indicated by line 1702) are shown on the left of the graph and values for an image edge (indicated by line 1704) are shown on the right. A curve 1705 for the rectilinear lens design having the idealized profile with zero distortion indicates that pixel angular resolution increases in a non-linear fashion towards the image edge.

In rectilinear lenses, a fixed angular displacement is spread over a greater number of pixels at the edges of the FOV compared to f-theta and quartic lenses with barrel distortion, respectively shown with curves 1710 and 1715. This increased magnification at the FOV edges for the rectilinear lens results in higher angular resolution and more detail in the edge regions of a thermal image compared to the center. While such rectilinear lens design is well-suited to some applications to reduce the need for distortion correction using image processing resources such as de-warping, the relative loss of resolution at the center of the FOV is suboptimal for thermal signature identification where increased detection range is desired. The center of the FOV is typically where the most important or critical information is captured, particularly as humans tend to focus their attention on the center of the FOV most often. In addition, the human eye has the highest visual acuity in the center of the FOV, corresponding to the fovea of the retina.

The first lens distortion embodiment comprising the f-theta lens design, indicated by curve 1710, shows a constant pixel angular resolution across the entirety of the FOV. As shown, the angular resolution of the f-theta lens is greater than that of the rectilinear lens design between field angles of zero and about 15 degrees. While there is a linear relationship between field height (i.e., a distance from the center of the FOV) and field angle for the f-theta lens, the f-theta distortion varies non-linearly with field height in the focal plane. This is because field height in the focal plane is a function of the tangent of the field angle.

For a relatively wide FOV, the lens distortion may be mathematically described using a polynomial lens model that includes higher-order polynomial terms (e.g., cubic and/or quartic terms) to implement the non-linear distortion across the entire FOV. The inventors have recognized that the use of higher-order terms beyond quadratic expressions are generally desired to accurately design the lens with the desired center field angular resolution and non-linear distortion characteristics, particularly with relatively wide-angle thermal imaging camera lenses. For example, a fourth-term polynomial distortion model is:

$$D ( r ) = {k}_{1} r + {k}_{2} {r}^{2} + {k}_{3} {r}^{3} + {k}_{4} {r}^{4}$$

where r is the field height and k₁, k₂, k₃, and k₄ are distortion coefficients that determine the extent of the distortion.

Other potentially suitable polynomial lens distortion models using higher-order terms include, by way of example without limitation, thin prism models, Poly3 models (third-order polynomial), PTLens models (fourth-order polynomial), general polynomial models, extended polynomial models, Brown-Conrady tangential and radial distortion models, Kannala-Brandt radial distortion models, and the like. Alternative lens design approaches involve the use of division models and model-free methods using finite element or phase analyses.

The second lens distortion embodiment comprising the quartic lens design indicated by curve 1715 shows an angular resolution that is approximately five degrees greater than that provided by the rectilinear lens design at the center of the FOV. The angular resolution remains higher between field angles of zero and about 15 degrees. The amount of distortion provided by the quartic lens design generally follows a more complex pattern, with increased non-linear distortion across the FOV as compared to the f-theta lens. For example, the center field of the FOV is described by quadratic distortion while the quartic distortion term (i.e., k₄r⁴) becomes more significant towards the edges.

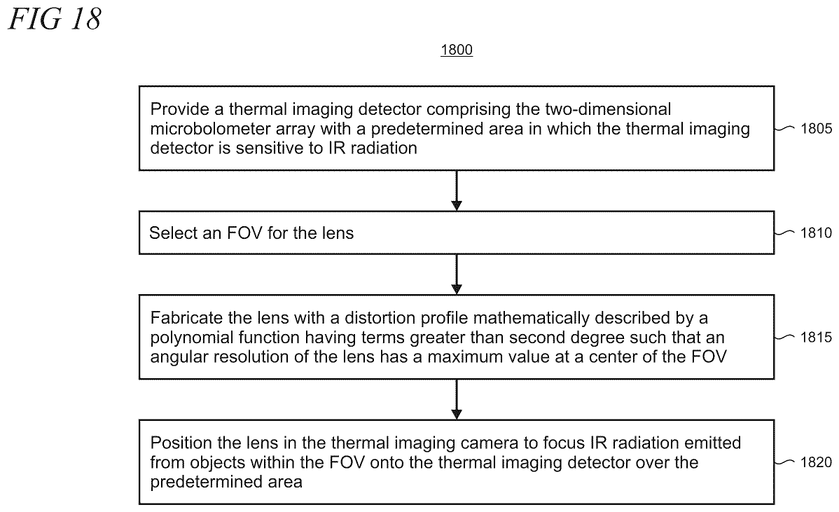

FIG. 18 is a flowchart 1800 of an illustrative method for improving center-field detection range of a thermal imaging camera having a two-dimensional microbolometer array and a lens. Unless specifically stated, the methods or steps shown in the flowchart and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

Block 1805 includes providing a thermal imaging detector comprising the two-dimensional microbolometer array with a predetermined area in which the thermal imaging detector is sensitive to IR radiation. Block 1810 includes selecting an FOV for the lens.

Block 1815 includes fabricating the lens with a barrel distortion profile mathematically described by a polynomial function having terms greater than second degree such that an angular resolution of the lens has a maximum value at a center of the FOV. Block 1820 comprises positioning the lens in the thermal imaging camera to focus IR radiation emitted from objects within the FOV onto the thermal imaging detector over the predetermined area.

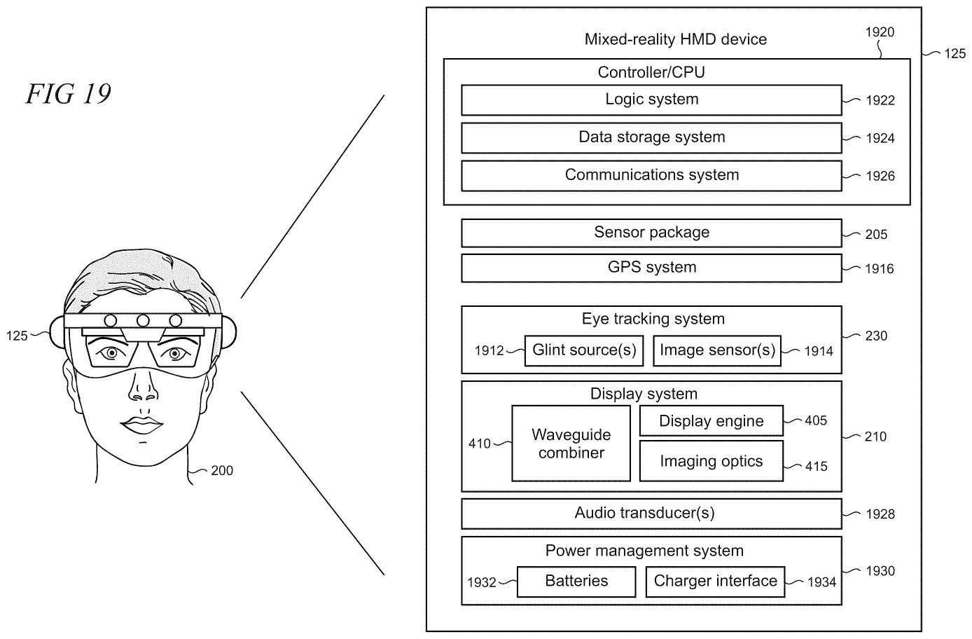

FIG. 19 is a block diagram of a mixed-reality HMD device 125. The HMD device 125 may include an eye tracking system 230 configured for detecting a direction of gaze of each eye of a user or a direction or location of focus. The eye tracking system is configured to determine gaze directions of each of a user's eyes in any suitable manner. For example, in the illustrative example shown, the eye tracking system includes one or more glint sources 1912, such as infrared light sources, that are configured to cause a glint of light to reflect from each eyeball of a user, and image sensors 1914, such as inward-facing cameras, that are configured to capture an image of each eyeball of the user. Changes in the glints from the user's eyeballs and/or a location of a user's pupil, as determined from image data gathered using the image sensors, are used to determine a direction of gaze.

In addition, a location at which gaze lines projected from the user's eyes intersect the display is used to determine an object at which the user is gazing (e.g., a displayed virtual object and/or real-world object). The eye tracking system 230 has any suitable number and arrangement of light sources and image sensors.

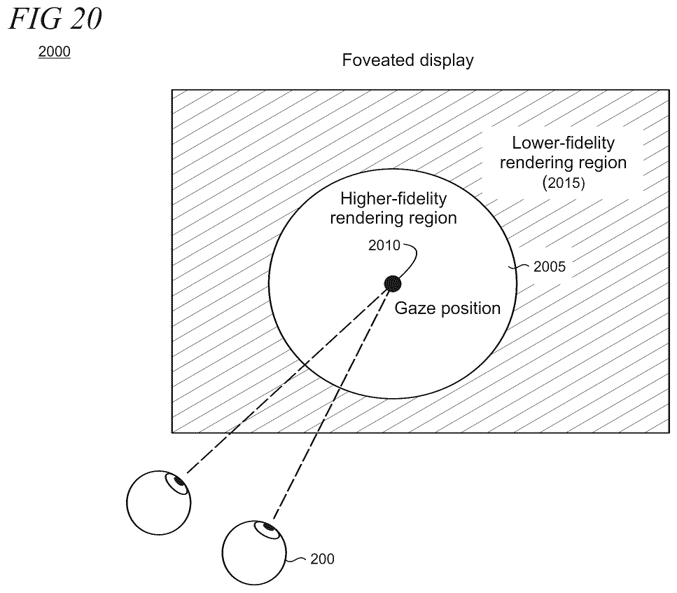

As shown in FIG. 20, the eye tracking system is usable to support a foveated display 2000, as discussed above, in which a region 2005 of the FOV around the user's gaze position 2010 is rendered with higher fidelity relative to the rest of the display.

Returning to FIG. 19, the HMD device 125 includes a display system 210 having a display engine 405, imaging optics 415, and a waveguide combiner 410, as described above. The HMD device comprises the sensor package 205 configured with optical sensors to acquire images and/or data of a physical environment around the device. Non-optical sensors may also be included in the sensor package such as electromagnetic sensors, ultrasonic sensors, and motion sensors such as IMUs. Motion sensors can be utilized to detect movement and position/orientation/pose of a user's head. Motion data is usable, potentially along with eye-tracking data and image data, for gaze detection, as well as for image stabilization to help correct for blur in images from the sensors. The use of motion data allows changes in gaze direction to be tracked in some cases even if image data from the sensors cannot be resolved.

Other sensors may also be utilized to meet the needs of a particular implementation. For example, biometric sensors (e.g., for detecting heart and respiration rates, blood pressure, brain activity, body temperature, etc.) or environmental sensors (e.g., for detecting temperature, humidity, elevation, UV (ultraviolet) light levels, etc.) are utilizable in some implementations of an HMD device.

The sensor package may include microphones configured to detect sounds, such as voice commands, from a user, and/or sounds from the environment. The HMD device 125 also includes, in some embodiments, a global positioning system (GPS) system 1916 to allow a location of the HMD device to be determined. This may help to identify real-world objects, such as buildings, etc., that are located in the user's surrounding physical environment.

The motion sensors and microphones in the sensor package 205 and eye tracking system 230 are employable as user input devices, such that a user interacts with the HMD device 125 via gestures of the eye, neck, and/or head, as well as via verbal commands in some cases.

The HMD device 125 further includes a controller 1920 such as one or more CPUs having a logic system 1922 and a data storage system 1924 in communication with the sensors in the sensor package 205, eye tracking system 230 and/or other HMD device components through a communications system 1926. The communications system facilitates the display system 210 being operated in conjunction with remotely located resources, such as processing, storage, power, data, and services. That is, in some implementations, an HMD device is operable as part of a system that distributes resources and capabilities among different components and systems.

A storage system 1924 includes instructions stored thereon that are executable by the logic system 1922, for example, to receive and interpret inputs from the sensors, to identify location and movements of a user, to identify real objects using surface reconstruction and other techniques, and dim/fade the display based on distance to objects so as to enable the objects to be seen by the user, among other tasks.

The HMD device 125 is configured with one or more audio transducers 1928 (e.g., speakers, earphones, etc.) so that audio can be utilized as part of a mixed-reality or virtual-reality experience. A power management system 1930 includes one or more batteries 1932 and/or protection circuit modules (PCMs) and an associated charger interface 1934 and/or remote power interface for supplying power to components in the HMD device.

It may be appreciated that the HMD device 125 is described for the purpose of example and thus is not meant to be limiting. It may be further understood that the display system includes, in some embodiments, additional and/or alternative sensors, cameras, microphones, input devices, output devices, etc. than those shown without departing from the scope of the present arrangement. Additionally, the physical configuration of an HMD device and its various sensors and subcomponents may take a variety of different forms without departing from the scope of the present arrangement.

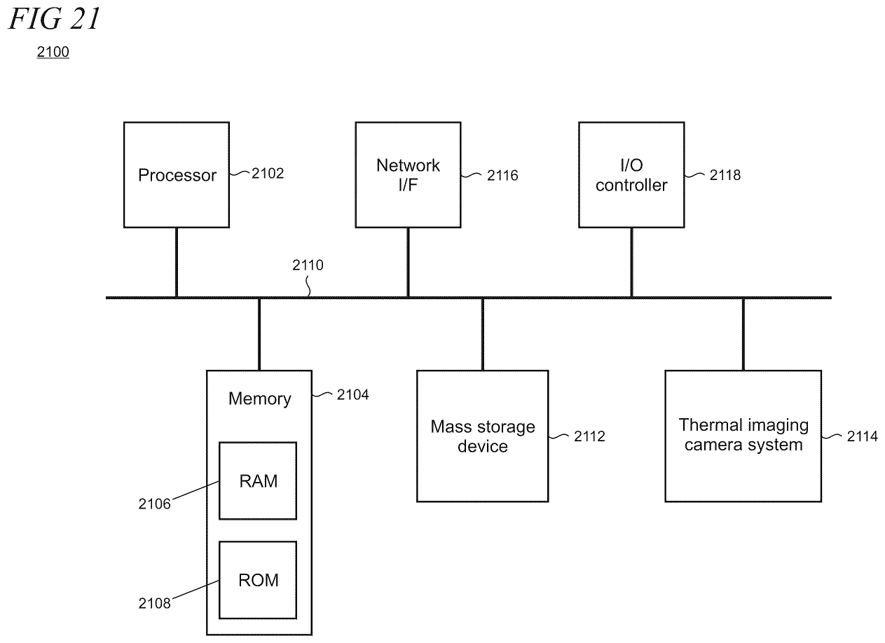

FIG. 21 schematically shows an illustrative example of a computing device 2100 that can enact one or more of the systems, features, functions, methods and/or processes described above. The computing device is shown in simplified form. The computing device may take the form of one or more personal computers, server computers, tablet computers, home-entertainment computers, network computing devices, gaming devices, mobile computing devices, mobile communication devices (e.g., smartphone), wearable computers, and/or other computing devices.

The computing device 2100 includes one or more processors 2102 (e.g., central processing unit, dedicated AI chip, graphics processing unit, etc.), a system memory 2104, including RAM (random access memory) 2106 and ROM (read only memory) 2108, and a system bus 2110 that operatively and functionally couples the components in the computing device. A basic input/output system containing the basic routines that help to transfer information between elements within the computing device, such as during startup, is typically stored in the ROM 2108. The computing device further includes a mass storage device 2112 for storing software code or other computer-executed code that is utilized to implement applications, a file system, and an operating system (OS). The mass storage device 2112 is connected to the processor 2102 through a mass storage controller (not shown) connected to the bus 2110. The mass storage device 2112 and its associated computer-readable storage media provide non-volatile storage for the computing device. Although the description of computer-readable storage media contained herein refers to a mass storage device, such as a hard disk or CD-ROM drive, it may be appreciated by those skilled in the art that computer-readable storage media can be any available storage media that can be accessed by the computing device.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray or other optical storage, magnetic cassettes, magnetic tape, magnetic disk storage or other magnetic storage devices, or any other medium which can be used to store the desired information and which can be accessed by the computing device.

According to various embodiments, the computing device 2100 may operate in a networked environment using logical connections to remote computers through a network. The computing device may connect to the network through a network interface unit 2116 connected to the bus 2110. It may be appreciated that the network interface unit 2116 also may be utilized to connect to other types of networks and remote computer systems. The computing device also may include an input/output controller 2118 for receiving and processing input from a number of other devices, including a keyboard, mouse, touchpad, touchscreen, control devices such as buttons and switches or electronic stylus (not shown in FIG. 21). Similarly, the input/output controller 2118 may provide output to a display screen, user interface, a printer, or other type of output device (also not shown in FIG. 21).

The computing device 2100 further includes a thermal imaging camera system 2114. The thermal imaging camera system is configurable in a similar manner to the system 100 described above. The camera system is integrated in the device 2100 or alternatively is a separate discrete component that is interoperable with the computing device. For example, when the computing device 2100 is a smartphone, the thermal imaging camera system is configurable as an accessory device that is operatively coupled to the smartphone using a suitable connector that supports, for example, the USB communications protocol.

It may be appreciated that the software components described herein may, when loaded into the processor 2102 and executed, transform the processor 2102 and the overall computing device 2100 from a general-purpose computing system into a special-purpose computing system customized to facilitate the functionality presented herein. The processor 2102 may be constructed from any number of transistors or other discrete circuit elements, which may individually or collectively assume any number of states. More specifically, the processor 2102 may operate as a finite-state machine, in response to executable instructions contained within the software modules disclosed herein. These computer-executable instructions may transform the processor 2102 by specifying how the processor 2102 transitions between states, thereby transforming the transistors or other discrete hardware elements constituting the processor 2102.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the computing device 2100 in order to store and execute the software components presented herein. It also may be appreciated that the computing device may include other types of computing devices, including wearable devices, handheld computers, embedded computer systems, smartphones, PDAs, and other types of computing devices known to those skilled in the art. It is also contemplated that the computing device may not include all of the components shown in FIG. 21, may include other components that are not explicitly shown in FIG. 21, or may utilize an architecture completely different from that shown in FIG. 21.

Various exemplary embodiments of the present thermal camera lens design with improved center-field detection range are now presented by way of illustration and not as an exhaustive list of all embodiments. An example includes a thermal imaging camera system arranged for capturing thermal images within a field of view (FOV), comprising: a thermal imaging sensor comprising a microbolometer array providing a focal plane array of pixels for a thermal image, the microbolometer array having sensitivity to infrared (IR) radiation, the microbolometer array converting the received IR radiation to an electrical signal representing the thermal image; and a lens arranged to focus IR radiation, emitted by a target within the FOV of the thermal imaging camera system, onto the microbolometer array, wherein the lens is configured with a barrel distortion profile that provides a pixel angular resolution for a central area of the FOV that is greater than or equal to a pixel angular resolution for edge areas of the FOV.

In another example, the thermal imaging camera system further comprises an image processor for processing the electrical signal from the microbolometer array to generate the thermal image for rendering on a display system. In another example, the image processor provides one or more of calibration, thermal image correction, gain control, dynamic range compression, thermal image detail enhancement, thermal image edge enhancement, noise reduction, color mapping, data filtering, data conversion, or image fusion. In another example, the thermal imaging camera system further comprises a user interface board configured to provide connectivity between the thermal imaging camera system and external systems or electronic devices for one or more of data transfer, power management, or configuration and control of the thermal imaging camera system. In another example, the user interface board provides a software interface to the thermal imaging camera system. In another example, the user interface board facilitates integration of the thermal imaging camera system as an internal component of an electronic device or as an external accessory component of the electronic device. In another example, the user interface board includes a connector supporting a standardized wired or wireless communication protocol.

A further example includes a head-mounted display (HMD) device wearable by a user and supporting a mixed-reality user experience comprising a display of virtual images for objects in a virtual world and views of objects in a real world, comprising: a display engine generating virtual images for the mixed-reality user experience; a see-through waveguide combiner configured to receive the virtual images from the display engine and display the virtual images, the see-through waveguide combiner being located on the HMD device in front of an eye of the user, and through which the user views the real world when the HMD device is donned; and a thermal imaging camera generating thermal images of target objects located in the real world within a field of view (FOV), the thermal imaging camera including a thermal imaging sensor comprising a two-dimensional array of pixels arranged in a focal plane implemented using microbolometers sensitive to infrared (IR) radiation and further including a non-rectilinear lens, wherein the non-rectilinear lens focuses IR radiation emitted from the target objects onto the thermal imaging sensor, and wherein the non-rectilinear lens imparts distortion to the focused IR radiation that varies non-linearly with a field height in the focal plane.

In another example, the non-rectilinear lens has an f-theta distortion profile. In another example, the non-rectilinear lens has a quartic distortion profile. In another example, the non-rectilinear lens provides a pixel angular resolution for a central area of the FOV that is substantially equal to a pixel angular resolution for edge areas of the FOV. In another example, the non-rectilinear lens provides a pixel angular resolution for a central area of the FOV that is greater than a pixel angular resolution for edge areas of the FOV. In another example, the HMD device further comprises a near-IR camera system. In another example, the thermal imaging sensor comprises an uncooled microbolometer array.

A further example includes a method for improving center-field detection range of a thermal imaging camera having a two-dimensional microbolometer array and lens, comprising: providing a thermal imaging detector comprising the two-dimensional microbolometer array with a predetermined area, the thermal imaging detector being sensitive to infrared (IR) radiation; selecting a field of view (FOV) for the lens; fabricating the lens with a distortion profile mathematically described by a polynomial function having terms greater than second degree such that angular resolution of the lens has a maximum value at a center of the FOV; and positioning the lens in the thermal imaging camera to focus IR radiation emitted from objects located within the FOV onto the thermal imaging detector over the predetermined area.

In another example, the angular resolution is constant over the FOV. In another example, the angular resolution decreases over the FOV from the maximum value at the center of the FOV to a minimum value at an edge of the FOV. In another example, the lens distortion profile comprises a barrel distortion profile. In another example, the polynomial function comprises one of thin prism model, PTlens model, Poly3 model, general polynomial model, extended polynomial model, Brown-Conrady model, or Kannala-Brandt model. In another example, the lens is fabricated from a material that transmits IR radiation.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A thermal imaging camera system arranged for capturing thermal images within a field of view (FOV), comprising:
a thermal imaging sensor comprising a microbolometer array providing a focal plane array of pixels for a thermal image, the microbolometer array having sensitivity to infrared (IR) radiation, the microbolometer array converting the received IR radiation to an electrical signal representing the thermal image; and
a lens arranged to focus IR radiation, emitted by a target within the FOV of the thermal imaging camera system, onto the microbolometer array,
wherein the lens is configured with a barrel distortion profile that provides a pixel angular resolution for a central area of the FOV that is greater than or equal to a pixel angular resolution for edge areas of the FOV.

2. The thermal imaging camera system of claim 1 further comprising an image processor for processing the electrical signal from the microbolometer array to generate the thermal image for rendering on a display system.

3. The thermal imaging camera system of claim 2 in which the image processor provides one or more of calibration, thermal image correction, gain control, dynamic range compression, thermal image detail enhancement, thermal image edge enhancement, noise reduction, color mapping, data filtering, data conversion, or image fusion.

4. The thermal imaging camera system of claim 1 further comprising a user interface board configured to provide connectivity between the thermal imaging camera system and external systems or electronic devices for one or more of data transfer, power management, or configuration and control of the thermal imaging camera system.

5. The thermal imaging camera system of claim 4 in which the user interface board provides a software interface to the thermal imaging camera system.

6. The thermal imaging camera system of claim 4 in which the user interface board facilitates integration of the thermal imaging camera system as an internal component of an electronic device or as an external accessory component of the electronic device.

7. The thermal imaging camera system of claim 4 in which the user interface board includes a connector supporting a standardized wired or wireless communication protocol.

8. A head-mounted display (HMD) device wearable by a user and supporting a mixed-reality user experience comprising a display of virtual images for objects in a virtual world and views of objects in a real world, comprising:
a display engine generating virtual images for the mixed-reality user experience;
a see-through waveguide combiner configured to receive the virtual images from the display engine and display the virtual images, the see-through waveguide combiner being located on the HMD device in front of an eye of the user, and through which the user views the real world when the HMD device is donned; and
a thermal imaging camera generating thermal images of target objects located in the real world within a field of view (FOV), the thermal imaging camera including a thermal imaging sensor comprising a two-dimensional array of pixels arranged in a focal plane implemented using microbolometers sensitive to infrared (IR) radiation and further including a non-rectilinear lens,
wherein the non-rectilinear lens focuses IR radiation emitted from the target objects onto the thermal imaging sensor, and
wherein the non-rectilinear lens imparts distortion to the focused IR radiation that varies non-linearly with a field height in the focal plane.

9. The HMD device of claim 8 in which the non-rectilinear lens has an f-theta distortion profile.

10. The HMD device of claim 8 in which the non-rectilinear lens has a quartic distortion profile.

11. The HMD device of claim 8 in which the non-rectilinear lens provides a pixel angular resolution for a central area of the FOV that is substantially equal to a pixel angular resolution for edge areas of the FOV.

12. The HMD device of claim 8 in which the non-rectilinear lens provides a pixel angular resolution for a central area of the FOV that is greater than a pixel angular resolution for edge areas of the FOV.

13. The HMD device of claim 8 further comprising a near-IR camera system.

14. The HMD device of claim 8 in which the thermal imaging sensor comprises an uncooled microbolometer array.

15. A method for improving center-field detection range of a thermal imaging camera having a two-dimensional microbolometer array and lens, comprising:
providing a thermal imaging detector comprising the two-dimensional microbolometer array with a predetermined area, the thermal imaging detector being sensitive to infrared (IR) radiation;
selecting a field of view (FOV) for the lens;
fabricating the lens with a distortion profile mathematically described by a polynomial function having terms greater than second degree such that an angular resolution of the lens has a maximum value at a center of the FOV; and
positioning the lens in the thermal imaging camera to focus IR radiation emitted from objects located within the FOV onto the thermal imaging detector over the predetermined area.

16. The method of claim 15 in which the angular resolution is constant over the FOV.

17. The method of claim 15 in which the angular resolution decreases over the FOV from the maximum value at the center of the FOV to a minimum value at an edge of the FOV.

18. The method of claim 15 in which the lens distortion profile comprises a barrel distortion profile.

19. The method of claim 15 in which the polynomial function comprises one of thin prism model, PTlens model, Poly3 model, general polynomial model, extended polynomial model, Brown-Conrady model, or Kannala-Brandt model.

20. The method of claim 15 in which the lens is fabricated from a material that transmits IR radiation.
